(19) United States
(12) Patent Application Publication
(10) Pub. No.: US 2013/0339070 A1
(43) Pub. Date: Dec. 19, 2013

(54) DYNAMIC PRICE-MONITOR SCHEDULING SYSTEMS AND METHODS

(71) Applicant: Yapta, Inc., Seattle, WA (US)

(72) Inventors: Karim MEGHJI, Sammamish, WA (US); Nathaniel SANDERS, Seattle, WA (US)

(21) Appl. No.: 13/918,665

(22) Filed: Jun. 14, 2013

Related U.S. Application Data
(60) Provisional application No. 61/659,822, filed on Jun. 14, 2012.

(51) Int. Cl. G06Q 10/02

(52) U.S. Cl. CPC G06Q 10/02
USPC 705/5

(57) ABSTRACT

To dynamically schedule price checks for a previously-purchased travel ticket, an initial travel-ticket-specific price-check interval is determined by modifying a base price-check interval according to two or more price-volatility factors associated with the travel ticket. After the initial travel-ticket-specific price-check interval has passed, at least one price check is performed to determine a current price associated with the travel ticket. Periodically, at least some of the price-volatility factors are re-evaluated to obtain two or more updated price-volatility factors. Periodically, an updated price-check interval is determined based at least in part on the updated price-volatility factors and an un-updated subset of the original price-volatility factors. A subsequent price check is scheduled to occur after the updated price-check interval has passed.

### CROSS-REFERENCE TO RELATED APPLICATIONS

This application claims the benefit of priority to Provisional Patent Application No. 61/659,822, filed Jun. 14, 2012 under Attorney Docket No. YAPT-2012004, titled “DYNAMIC PRICE-MONITOR SCHEDULING SYSTEMS AND METHODS”, and naming inventor Karim MEGHJI The above-cited application is hereby incorporated by reference, in its entirety, for all purposes.

### FIELD

This disclosure is directed to computer-based price monitoring. More particularly, this disclosure is directed to post-purchase price-monitoring for goods or services such as airline flights, hotels, and other travel products that are commonly purchased in advance and whose prices exhibit variable volatility.

### BACKGROUND

As in most industries, modern airlines typically price to their services in an attempt to maximize profitability. The pricing of airline tickets has become increasingly complicated and is commonly determined by computerized yield management systems.

Many airlines use differentiated pricing schemes to simultaneously sell air services at varying prices to different segments. Factors influencing the price frequently include the days remaining until departure, the booked load factor, the forecast of total demand by price point, competitive pricing in force, variations by day of week and/or by time of day, and the like.

Moreover, carriers often segment airfares into multiple travel classes for pricing purposes. Such travel classes are often represented by a “class code” or reservations/booking designator such as “F” and “P” for first class and first class premium, “C” and “J” for business and business premium, “Y” for economy/coach, and so on. With the advent of cheaper fares and more frequent travel, there may be dozens of available travel classes, with a corresponding number of class codes to differentiate between them.

Since the late 1970s, computerized reservations systems (“CRS”) have been used by airlines and travel agencies to store and retrieve information and conduct transactions related to air travel. Large CRS operations that book and sell tickets for multiple airlines are also known as global distribution systems (“GDS”). In addition to airline tickets, some modern computerized reservations systems also allow users to book other travel-related services, such as hotel rooms and rental cars. Examples of major computerized reservations systems include Sabre Global Distribution System, provided by Sabre Holdings Corporation of Southlake, Tex.; Amadeus CRS, provided by Amadeus IT Holding S.A. of Madrid, Spain; Worldspan and Galileo CRS, both provided by Travelport Limited of Atlanta, Ga.; and the like.

Airlines commonly use the Airline Tariff Publishing Company of Washington, D.C. to distribute airfares to Computer Reservation Systems across the world. Airlines typically distribute airfares at least once per day, frequently several times daily, or even hourly for some markets.

The pricing volatility and complexity in the airfare market can present challenges for travelers who wish to find the best deal or have the confidence to book early when purchasing air travel, challenges that are multiplied for businesses that purchase air travel in large quantities.

### BRIEF DESCRIPTION OF THE DRAWINGS

FIG. 1 illustrates a simplified airfare price-monitoring system in which price-monitoring server, CRS Servers, and travel-provider server are connected to network.

FIG. 2 illustrates several components of an exemplary price-monitoring server in accordance with one embodiment.

FIG. 3 illustrates simplified conceptual models of a ticket-monitor record such as may be extracted from a flight passenger name record, in accordance with one embodiment.

FIG. 4 illustrates a routine for dynamically scheduling price checks, such as may be performed by a price-monitoring server in accordance with one embodiment.

FIG. 5 illustrates a subroutine for determining a time interval before performing a next price-check for a given travel product, such as may be performed by a price-monitoring server in accordance with one embodiment.

FIG. 6 illustrates a routine for dynamically scheduling price checks, such as may be performed by a price-monitoring server in accordance with one embodiment.

FIGS. 7-11 illustrate several charts visualizing several exemplary price-volatility factors.

### DESCRIPTION

Some computerized reservations systems charge a fee for obtaining current prices for airline tickets, hotel rooms, and/or other travel products. Such fees are usually on the order of a few pennies, but the costs of making frequent requests for a large number of travel-product prices can add up quickly. Consequently, price-monitoring services may wish to control costs by dynamically determining a schedule for making such price requests, such as described variously below.

Conversely, some travel products may exhibit higher volatility than others based on various factors described herein. Consequently, price-monitoring services may wish to increase identification of savings opportunities by dynamically determining a schedule for making such price requests, such as described variously below.

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

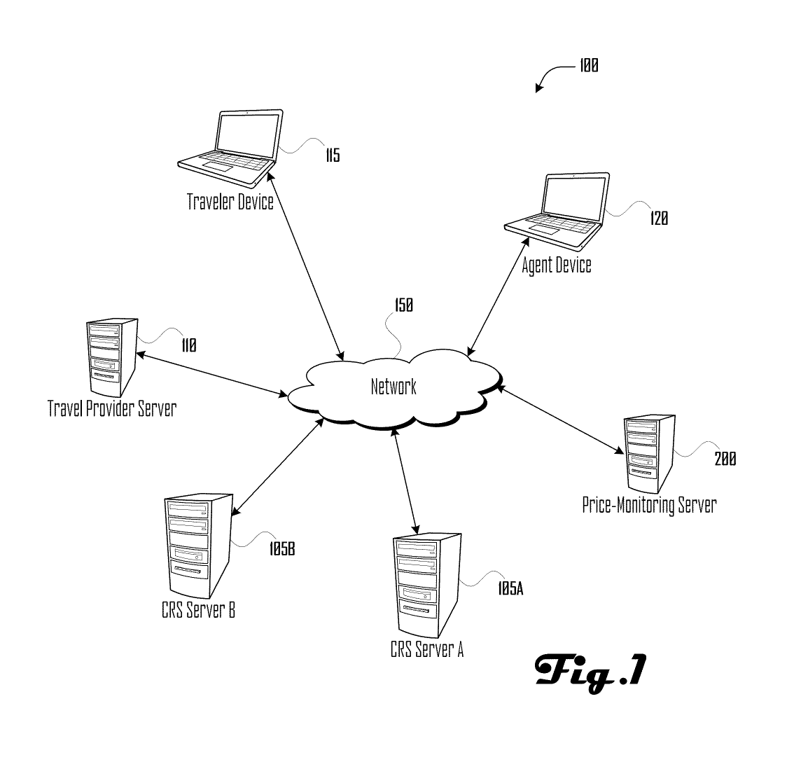

FIG. 1 illustrates a simplified airfare price-monitoring system in which price-monitoring server 200, CRS Servers 105A-B, and travel-provider server 110 are connected to network 150. In an exemplary scenario, an individual traveler or an entity that employs or is otherwise associated with travelers may engage a travel agency to purchase flights and/or other travel products via one more of CRS Servers 105A-B. Either the passenger, an entity associated with the passenger (e.g., the passenger's employer), or the travel agency may engage a price monitoring service that operates price-monitoring server 200 to monitor post-purchase price changes for savings opportunities. In some embodiments, price-monitoring server 200 may also be operated by the travel agency.

In various embodiments, network 150 may include the Internet, a local area network (“LAN”), a wide area network (“WAN”), and/or other data network. In various embodiments, additional infrastructure (e.g., cell sites, routers, gateways, firewalls, and the like), as well as additional devices (e.g., devices operated by airlines) may be present. Further, in some embodiments, the functions described as being provided by some or all of price-monitoring server 200, CRS Servers 105A-B, and/or travel-provider server 110 may be implemented via various combinations of physical and/or logical devices. However, it is not necessary to show such infrastructure and implementation details in FIG. 1 in order to describe an illustrative embodiment.

In various embodiments, price-monitoring server 200 may comprise one or more physical and/or logical devices that collectively provide the functionalities described herein. In some embodiments, price-monitoring server 200 may comprise one or more replicated and/or distributed physical or logical devices.

In some embodiments, price-monitoring server 200 may comprise one or more computing services provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

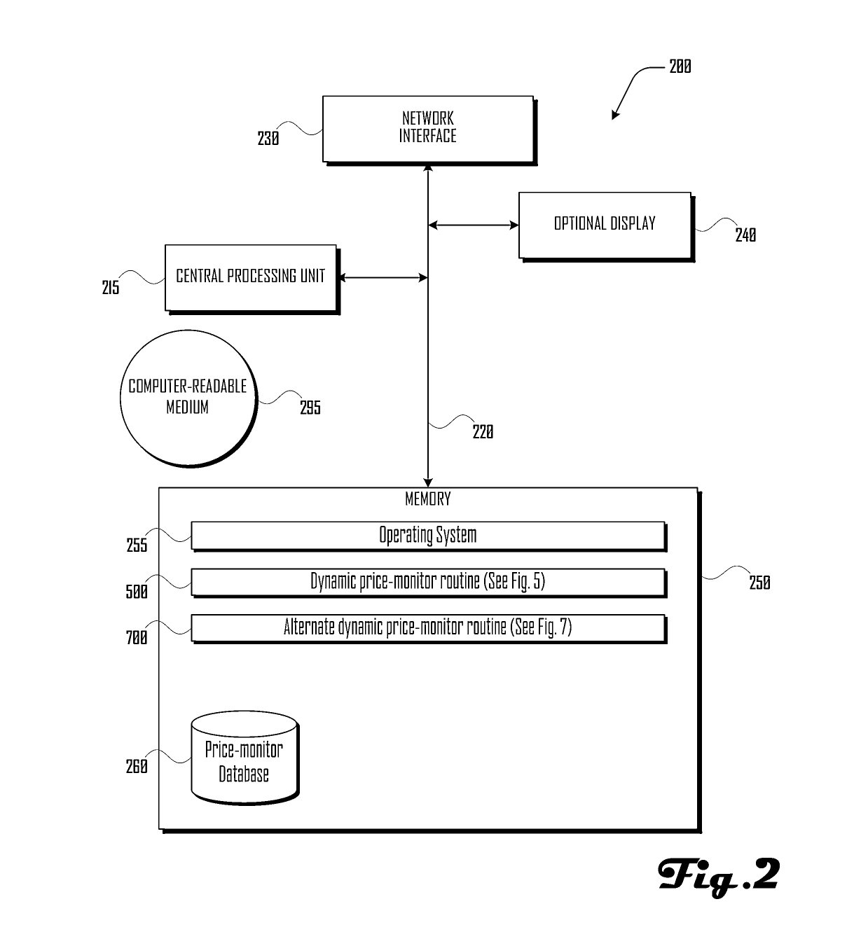

FIG. 2 illustrates several components of an exemplary price-monitoring server in accordance with one embodiment. In some embodiments, price-monitoring server 200 may include many more components than those shown in FIG. 2. However, it is not necessary that all of these generally conventional components be shown in order to disclose an illustrative embodiment.

Price-monitoring server 200 includes a bus 220 interconnecting components including a processing unit 210; a memory 250; optional display 240; and network interface 230.

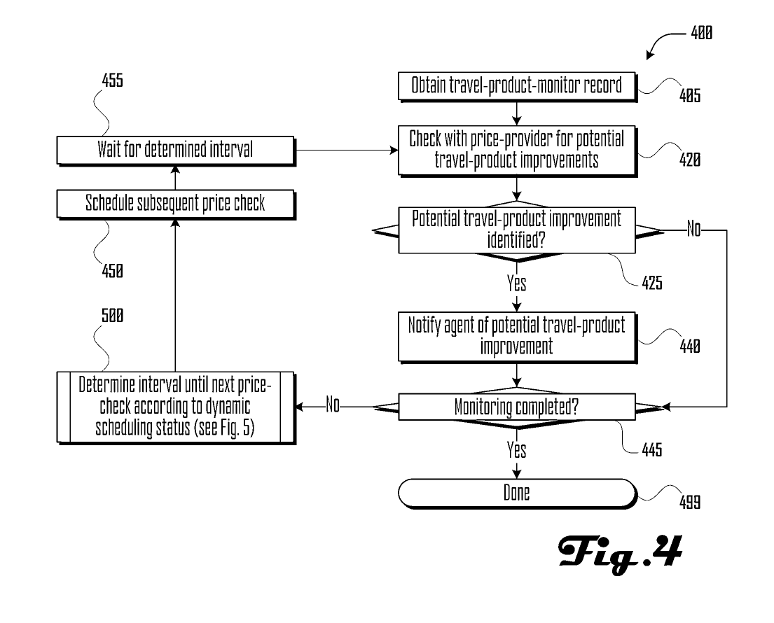

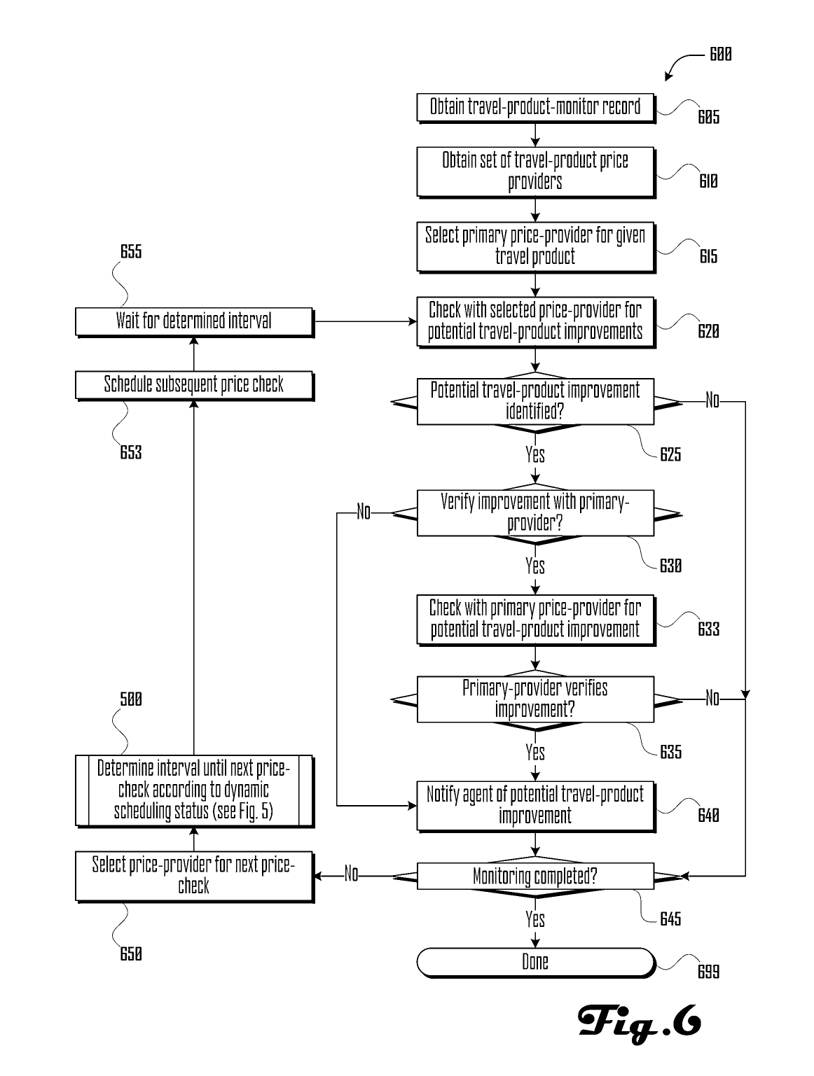

Memory 250 generally comprises a random access memory (“RAM”), a read only memory (“ROM”), and a permanent mass storage device, such as a disk drive. The memory 250 stores program code for a routine 400 for dynamically scheduling price checks (see FIG. 4, discussed below) and a routine 600 for dynamically scheduling price checks (see FIG. 6, discussed below). In addition, the memory 250 also stores an operating system 255.

These and other software components may be loaded into memory 250 of price-monitoring server 200 using a drive mechanism (not shown) associated with a non-transient computer readable storage medium 295, such as a floppy disc, tape, DVD/CD-ROM drive, memory card, or the like. In some embodiments, software components may alternately be loaded via the network interface 230, rather than via a non-transient computer readable storage medium 295.

Memory 250 also includes database 260, which stores records including records 265A-D.

In some embodiments, price-monitoring server 200 may communicate with database 260 via network interface 230, a storage area network (“SAN”), a high-speed serial bus, and/or via the other suitable communication technology.

In some embodiments, database 260 may comprise one or more storage services provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

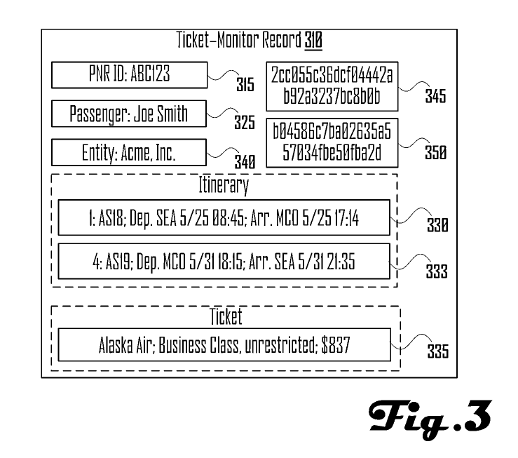

FIG. 3 illustrates simplified conceptual models of a ticket-monitor record 310 such as may be extracted from a flight passenger name record (“PNR”), in accordance with one embodiment. Although monitor records corresponding to airline flights are illustrated, similar data structures could be employed for monitoring other travel products, such as hotel rooms, rental cars, and the like. Similarly, various embodiments may employ variations on the exemplary ticket-monitor record 310 shown in FIG. 3, which variations may include more, fewer, and/or different attributes than those shown.

Briefly, ticket-monitor record 310 includes an identifier 315, usually referred to as a “Record Locator”, that uniquely identifies a PNR at a given point in time. Ticket-monitor record 310 also includes name(s) of the traveler(s) 325; an entity 340 associated with the traveler (e.g. the traveler's employer); itinerary data 330, 333; ticket data 335; and travel-fingerprints 345 and 350. For purposes of this disclosure, ticket-monitor record 310 may be obtained via any suitable means and need only provide sufficient data to be able to schedule and perform a price-check, as described below. Ticket-monitor record 310 (as well as methods for extracting a ticket-monitor record from a flight PNR) is described in greater detail in U.S. patent application Ser. No. 13/888,991, titled “FLIGHT-PRICE MONITORING SYSTEMS AND METHODS”, filed May 7, 2013 under attorney docket number YAPT-2013005, and naming inventors Russell Barber et al, which application is hereby incorporated by reference in its entirety, for all purposes.

FIG. 4 illustrates a routine 400 for dynamically scheduling price checks, such as may be performed by a price-monitoring server 200 in accordance with one embodiment.

In block 405, routine 400 obtains a travel-product monitor record (e.g., record 310).

In block 420, routine 400 requests and obtains from a price-provider up-to-date price information for one or more travel products that are identical to or at least equivalent to the given travel product (e.g., a flight with the same origin/destination pair, on the same airline, scheduled for similar departure/arrival times, with a similar or improved class of service, with similar or improved relevant restrictions, and the like).

In decision block 425, routine 400 determines whether the up-to-date information obtained in block 420 indicates a potential “improvement” to the given travel product. For example, in one embodiment, a flight ticket or hotel booking that is identical to the given travel product, but has a lower price, may be a potential “improvement”. In another embodiment, a flight ticket or hotel booking that is similar in price to the given travel product, but has fewer relevant restrictions and/or an improved class of service (e.g., business class versus economy class) may also be a potential “improvement”.

If in decision block 425, routine 400 determines that no potential improvement was identified, then routine 400 proceeds to decision block 445 (see discussion below) to determine whether price-monitoring for the given travel product has been completed.

Otherwise, if routine 400 determines that a potential improvement was identified, then routine 400 proceeds to block 440.

In block 440, routine 400 notifies a booking agent of the potential travel-product improvement.

In decision block 445, routine 400 determines whether price-monitoring for the given travel product has been completed. For example, in one embodiment, price-monitoring for a travel product may be predetermined to continue until shortly before the commencement of the travel (e.g., until one or more days or hours before a flight departs, before a hotel check in, or the like). In other embodiments, monitoring for a given travel product may continue until a predetermined number of price-checks have been performed, until a predetermined number of improvements have been identified and/or captured, until the travel product is improved to the point that further improvements are unlikely, or the like.

If in decision block 445, routine 400 determines that price-monitoring for the given travel product is complete, then routine 400 ends in ending block 499. Otherwise, routine 400 proceeds to subroutine block 500.

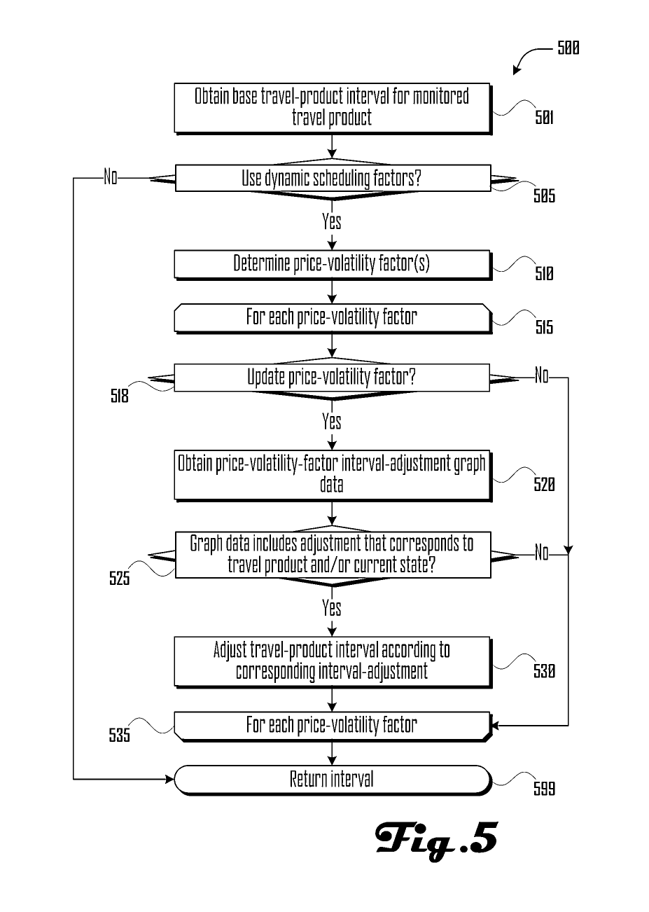

In subroutine block 500, routine 400 calls subroutine 500 (see FIG. 5, discussed below) to determine a time interval until the next price-check is to be performed for the given travel product and the selected price-provider.

In block 450, routine 400 schedules a subsequent price check to occur after the price-check time-interval determined in subroutine block 500 has passed.

In block 455, routine 400 waits for the determined time interval before proceeding to block 420 (discussed above) to perform the next price-check.

Routine 400 ends in ending block 499.

FIG. 5 illustrates a subroutine 500 for determining a time interval before performing a next price-check for a given travel product, such as may be performed by a price-monitoring server 200 in accordance with one embodiment.

In block 501, subroutine 500 obtains a “base” time interval between price-checks. For example, in one embodiment, a static base time interval of six, eight, or twelve hours may be employed for all travel products. In other embodiments, subroutine 500 may select a base interval according to factors such as the travel product type (e.g., eight hours for airline flights, 16 hours for hotels, 24 hours for car rentals), client type (e.g., six hours for clients who use paid price-monitoring versus 12 hours for clients who use free price monitoring, such as in a “freemium” business model), or the like.

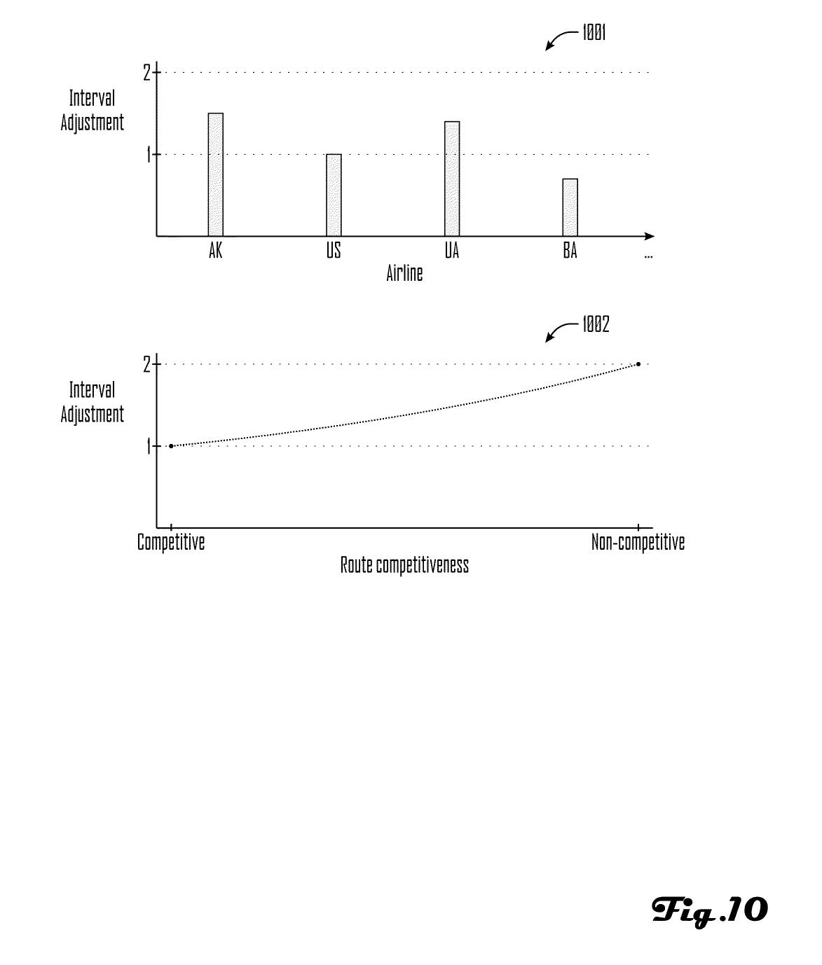

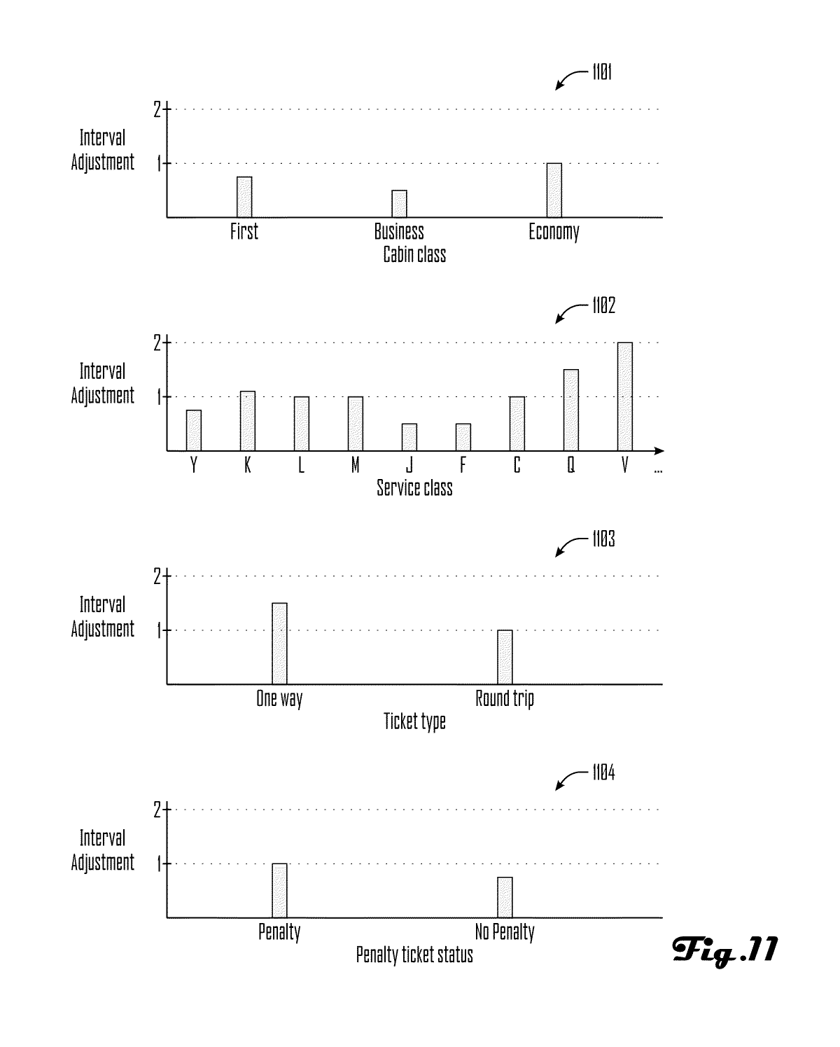

In some embodiments, such as when one or more previous price checks have been performed for a given travel product, the “base” time interval may include adjustments for one or more static (non-time-varying) price-volatility factors. For example, in one embodiment, the “base” time interval may already include adjustments according to one or more of the non-time-varying price-volatility factor visualizations shown in FIGS. 10-11, discussed below.

In decision block 505, subroutine 500 determines whether it was called with instructions to use dynamic scheduling factors. If subroutine 500 determines to disregard dynamic-scheduling factors, then subroutine 500 ends in ending block 599, returning the base interval determined in block 501.

Otherwise, if in decision block 505, subroutine 500 determines to perform dynamic interval-determination, then subroutine 500 proceeds to block 510.

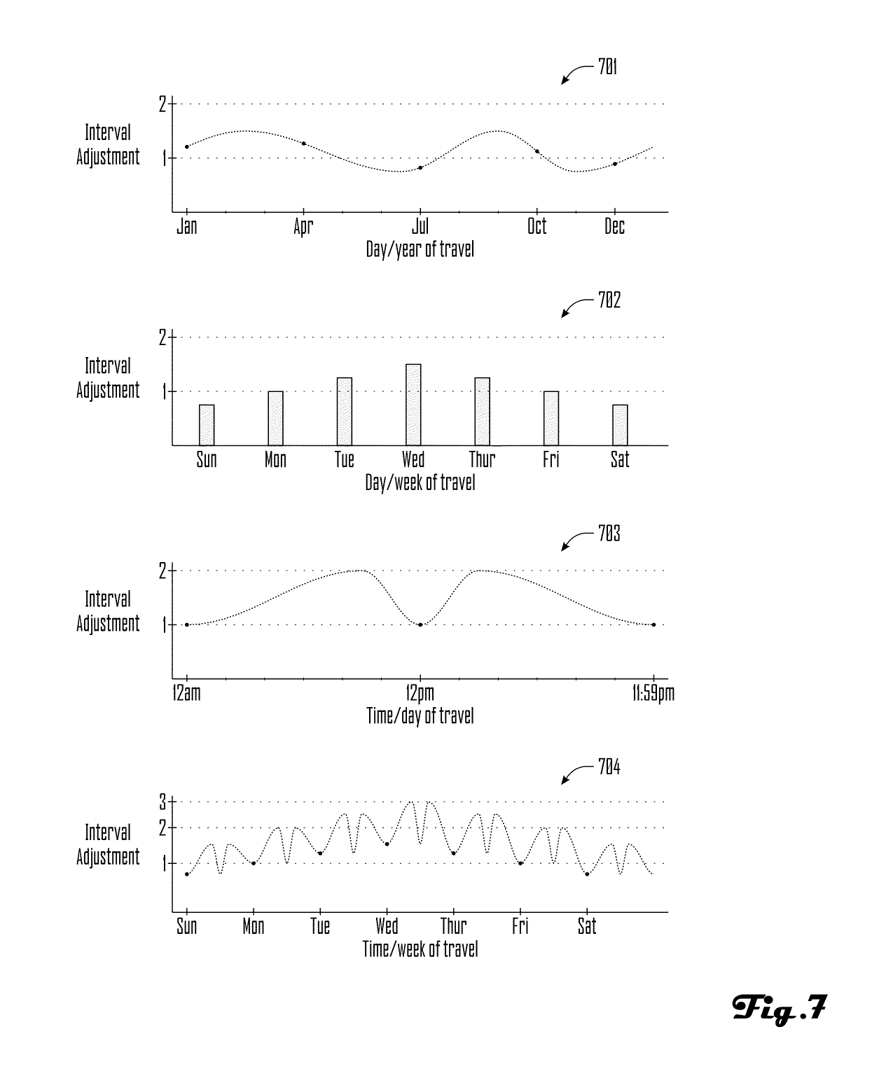

In block 510, subroutine 500 determines one or more “price-volatility factors” that collectively suggest how volatile prices for the given travel product are likely to be at the current time. See, e.g., the price-volatility factor visualizations shown in FIGS. 7-11, discussed below.

Beginning in opening loop block 515, subroutine 500 processes each price-volatility factor in turn.

In decision block 518, subroutine 500 determines whether the current price-volatility factor is associated with an adjustment value determined during a previous price-check. If so, and if the current price-volatility factor is time-varying, then subroutine 500 proceeds to block 520 to re-evaluate the current price-volatility factor during the current price-check period. Otherwise, the current price-volatility factor does not need updating, and subroutine 500 proceeds to ending loop block 535.

In block 520, subroutine 500 obtains data corresponding to an interval-adjustment “graph” for the current dynamic scheduling factor. As the term is used herein, an interval-adjustment “graph” refers to a set of data for modifying the travel-product price-check interval according to an axis of variation.

In decision block 525, subroutine 500 determines whether the interval-adjustment graph data includes a multiplier or other adjustment value (e.g., an addend, subtrahend, divisor, factor, exponent, radical index, or the like) that corresponds to the current travel product and/or current state (e.g., current month, day, date, time, or the like).

For example, when processing a dynamic scheduling factor related to travel-product price-volatility according to the current day of the week, subroutine 500 may in block 520 obtain graph data similar to that discussed above and visualized in chart 702 (see FIG. 7, discussed below), and in decision block 525, subroutine 500 may determine that the graph data includes an adjustment value corresponding to the current day of the week. In such a case, subroutine 500 proceeds to block 530.

In other cases, the graph data may not include adjustment values covering all possible cases. For example, when processing a dynamic scheduling factor related to travel-product price-volatility according to origin/destination pair (see, e.g., chart 1001), the graph data may not include adjustment values for all possible airlines, and if the given travel product is provided by an airline that is not covered by the graph data, then in decision block 525, subroutine 500 may determine that the graph data does not include an adjustment corresponding to the given travel product.

In block 530, subroutine 500 adjusts the travel-product price-check interval (originally obtained in block 501, possibly modified in a previous iteration of loop 515-535) according to the adjustment value (as determined in decision block 525). For example if the “base” time interval has a current value of 8 hours and the adjustment value is a multiplier with a value of 0.75, then in block 530, subroutine 500 may adjust the travel-product price-check interval to have a value of 6 hours.

In ending loop block 535, subroutine 500 iterates back to opening loop block 515 to process the next price-volatility factor, if any.

Once all price-volatility factors have been processed, subroutine 500 ends in ending block 599, returning the travel-product price-check interval to the caller.

FIG. 6 illustrates a routine 600 for dynamically scheduling price checks, such as may be performed by a price-monitoring server 200 in accordance with one embodiment.

In block 605, routine 600 obtains a travel-product monitor record (e.g., record 310).

In block 610, routine 600 identifies one or more price providers that may potentially be able to provide up-to-date pricing information for the travel product(s) indicated by the travel-product monitor record (as obtained in block 605). For example, in some embodiments, routine 600 may consult a predetermined list of travel-product-price providers to identify one or more computerized reservations systems (“CRS”s) from which routine 600 can access up-to-date price data for a given type of travel product. In some embodiments, routine 600 may also be able to obtain travel-product prices from a non-CRS source, such as from an airline, hotel, or other travel-product provider. In some embodiments, such non-CRS sources may provide an application programming interface (“API”) to facilitate price-checking operations. In other embodiments, up-to-date price data for a travel product may be available via non-CRS sources using web scraping or web data extraction techniques for identifying and structuring web data using an automated and/or simulated web browser.

In block 615, routine 600 determines which of the price providers identified in block 610 is considered the “primary” price-provider for the travel product in question. Frequently, it is only practical to make a change to the travel product through the same provider through which the travel product was initially booked and/or purchased. Consequently, in many cases, the primary price provider is determined to be the provider through which the travel product was purchased. For example, if a flight or other travel product was purchased through Sabre Global Distribution System, then Sabre Global Distribution System may be determined to be the primary price-provider for that travel product.

In block 620, routine 600 requests and obtains from the selected price-provider up-to-date price information for one or more travel products that are identical to or at least equivalent to the given travel product (e.g., a flight with the same origin/destination pair, on the same airline, scheduled for similar departure/arrival times, with a similar or improved class of service, with similar or improved relevant restrictions, and the like).

In decision block 625, routine 600 determines whether the up-to-date information obtained in block 620 indicates a potential “improvement” to the given travel product. For example, in one embodiment, a flight ticket or hotel booking that is identical to the given travel product, but has a lower price, may be a potential “improvement”. In another embodiment, a flight ticket or hotel booking that is similar in price to the given travel product, but has fewer relevant restrictions and/or an improved class of service (e.g., business class versus economy class) may also be a potential “improvement”.

If in decision block 625, routine 600 determines that no potential improvement was identified, then routine 600 proceeds to decision block 645 (see discussion below) to determine whether price-monitoring for the given travel product has been completed.

Otherwise, if routine 600 determines that a potential improvement was identified, then routine 600 proceeds to decision block 630.

In decision block 630, routine 600 determines whether to verify the improvement with a primary price-provider (see discussion of block 500C in FIG. 4, above). For example, the given price-provider may have low monitoring costs, but may have potentially unreliable data (e.g, the given price-provider may occasionally indicate prices and/or improvements that could not actually be captured via the primary price-provider).

If in decision block 630 routine 600 determines not to verify the improvement with a primary price-provider, then routine 600 proceeds to block 640 (discussed below). Otherwise, routine 600 proceeds to block 633.

In block 633, routine 600 requests from the primary price-provider price information for the potential improvement identified in decision block 625.

In decision block 635, routine 600 determines whether the primary price-provider verified that the improvement to the travel product exists and could be captured. If not, then routine 600 proceeds to decision block 645 (see discussion below) to determine whether price-monitoring for the given travel product has been completed. Otherwise, routine 600 proceeds to block 640.

In block 640, routine 600 notifies a booking agent of the potential travel-product improvement.

In decision block 645, routine 600 determines whether price-monitoring for the given travel product has been completed. For example, in one embodiment, price-monitoring for a travel product may be predetermined to continue until shortly before the commencement of the travel (e.g., until one or more days or hours before a flight departs, before a hotel check in, or the like). In other embodiments, monitoring for a given travel product may continue until a predetermined number of price-checks have been performed, until a predetermined number of improvements have been identified and/or captured, until the travel product is improved to the point that further improvements are unlikely, or the like.

If in decision block 645, routine 600 determines that price-monitoring for the given travel product is complete, then routine 600 ends in ending block 699. Otherwise, routine 600 proceeds to block 650.

In block 650, routine 600 selects a price-provider for the next price-check. In various embodiments, routine 600 may select a next price-provider based on considerations such as some or all of those discussed below.

For example, in some embodiments, routine 600 may select a next price-provider based at least in part on the costs associated with monitoring prices through the primary price-provider, as compared to costs associated with other price-providers. For example, as discussed above, some computerized reservations systems (e.g., Sabre Global Distribution System) charge a fee on the order of a few pennies for obtaining a current price for an airline ticket, hotel room, and/or other travel product. Other computerized reservations systems (e.g., Worldspan) may charge a lower fee (e.g., a fraction of a penny) for similar requests. On the other hand, non-CRS price-providers (e.g., an airline website) may not charge a fee at all. In one embodiment, low-cost price-providers (e.g., those that charge nothing or less than a penny for providing a current travel product price) may be used more frequently than higher-cost providers.

Similarly, in some embodiments, routine 600 may select a next price-provider based at least in part on the likelihood that a given price-provider will have accurate prices for the given travel product. For example, some price-providers may provide prices only for certain airlines, hotels, or other travel-product provider and would therefore be unlikely to have prices if the travel product being monitored came from a different airline, hotel, or other travel-product provider. Such price-providers may be used infrequently or never.

Alternately, in some cases, the travel product being monitored may have been purchased at a discounted rate that is only published to certain price-providers. For example, a large company may have negotiated discounted rates with airlines, hotels, and other travel providers. Those discounted corporate rates may be published to only certain price-providers (e.g., to Sabre Global Distribution System, but not Worldspan). Therefore, if the travel product being monitored was purchased at a discounted corporate rate that is published only to Sabre Global Distribution System, then Worldspan (as well as other price-providers) may be unlikely to be able to provide accurate prices for that travel product, and Worldspan (and other price-providers) may be used infrequently or never.

Similarly, in some embodiments, routine 600 may select a next price-provider based at least in part on business and/or contractual considerations. For example, in one embodiment, a price-monitoring service may establish certain guidelines or targets for price-provider selection, such as targeting the primary price-provider for at least 25% of price-checks and targeting alternate, lower-cost price-providers for no more than 75% of price checks. Similarly, in some embodiments, a price-monitoring service may determine that primary price-providers should be selected at least N times per day or per week, where N may be a constant value (e.g., one time per day), or N may vary by client and/or customer or by the amount of time left before travel commences, or by other factors (e.g., two times a day for premium clients, one time a day for others; three times per week prior to a month before travel, six times per week during the month before travel; or the like).

In some embodiments, routine 600 may select a next price-provider based at least in part on lifetime-costs for monitoring travel products of a certain type. For example, in one embodiment, a price-monitoring service may establish a lifetime-monitoring-cost target of, e.g., three dollars for a certain type of travel product (e.g., international flights, travel products with a purchase-price above $1,000 or some other threshold, or the like). In such embodiments, routine 600 may track the price-check-history for a given travel product and consider the amount spent compared to the lifetime target compared to the time remaining before travel when selecting a next price-provider.

In subroutine block 500, routine 600 calls subroutine 500 to determine a time interval until the next price-check is to be performed for the given travel product and the selected price-provider.

In block 653, routine 600 schedules a subsequent price check to occur after the price-check time-interval determined in subroutine block 500 has passed.

In block 655, routine 600 waits for the determined time interval before proceeding to block 620 (discussed above) to perform the next price-check.

Routine 600 ends in ending block 699.

FIG. 7 illustrates several charts visualizing several exemplary price-volatility factors. More specifically, FIG. 7 illustrates exemplary price-volatility factors based on travel-date/time. The price-volatility factor visualizations shown in FIG. 7 are intended to be merely illustrative of the concepts described herein, and not necessarily indicative of actual price-volatility-factor data that may be used in commercial embodiments.

In charts 701-704, the y-axis (Interval Adjustment) varies inversely according to the expected favorability for identifying a potentially improved travel product and/or travel-product price, according to the x-axis scale. As illustrated in charts 701-704, the y-axis represents a multiplier for increasing the interval (less frequent price-checks) or decreasing the interval (more frequent price-checks) according to price-volatility factors based on travel-date/time.

For example, chart 701 illustrates that travel-product price-volatility in general varies according to the current season, with periods of higher volatility around May-June and October-December.

In various embodiments, the data from which chart 701 may be derived (as well as other data sets described herein) may be stored and/or represented in a suitable data structure as xy pairs, key:value pairs, database records, or other form that enables an interval adjustment value to be accessed based on an index. For example, in one embodiment, graph data corresponding to chart 701 (in which adjustment values vary according to a day/year of travel) may be represented and/or stored in a key:value data structure as follows:

| | |
|---|---|
| “8”: | 1.5 |
| “10”: | 0.75 |
| “−2”: | 0.75 |
| “1.5”: | 1.5 |
| “5.5”: | 0.75 |
| “13.5”: | 1.5 |

In another embodiment, the same graph data may be stored and/or represented in an array or list indexed according to a value corresponding to the day/year of travel (e.g., 0-11, corresponding to “Jan”-“Dec”):

[1.208, 1.463, 1.471, 1.269, 0.981, 0.779, 0.822, 1.241, 1.500,
1.125, 0.750, 0.891]

To facilitate human comprehension, this and other example data objects depicted herein are presented according to version 1.2 of the YAML “human friendly data serialization standard”, specified at http://www.yaml.org/spec/1.2/spec.html. In practice, data objects may be serialized for storage and/or transmission into any suitable format (e.g., YAML, JSON, XML, BSON, Property Lists, or the like).

Chart 702 illustrates that travel-product price-volatility in general varies according to the day of the week on which the travel begins, with lower volatility towards the middle of the week, and higher volatility towards the week ends.

As discussed above, in various embodiments, the data from which chart 702 may be derived may be stored and/or represented in any suitable data structure. For example, in one embodiment, graph data corresponding to chart 702 (in which adjustment values vary according to a day/week of travel) may be represented and/or stored in a key:value data structure as follows:

| | |
|---|---|
| Sun: | 0.75 |
| Mon: | 1 |
| Tue: | 1.25 |
| Wed: | 1.5 |
| Thur: | 1.25 |
| Fri: | 1 |
| Sat: | 0.75 |

In another embodiment, the same graph data may be stored and/or represented in an array or list indexed according to a value corresponding to the day/week of travel (e.g., 0-6, corresponding to “Sun”-“Sat”):

[0.75, 1, 1.25, 1.5, 1.25, 1, 0.75]

Chart 703 illustrates that travel-product price-volatility in general varies according to the time of day the travel takes place, with periods of lower volatility during mid-morning and mid-afternoon periods.

As discussed above, in various embodiments, the data from which chart 703 may be derived may be stored and/or represented in any suitable data structure. For example, in one embodiment, graph data corresponding to chart 703 (in which adjustment values vary according to a time/day of travel) may be represented and/or stored in a key:value data structure as follows:

| | |
|---|---|
| “0”: | 1 |
| “9”: | 2 |
| “12”: | 1 |
| “15”: | 2 |
| “24”: | 1 |

In another embodiment, the same graph data may be stored and/or represented in an array or list indexed according to a value corresponding to the time/day of travel (e.g., 0-24, corresponding to “12 am”-“11:59 pm”):

[1.000, 1.030, 1.117, 1.250, 1.413, 1.587, 1.750, 1.883, 1.970,
2.000, 1.750, 1.250, 1.000, 1.250, 1.750, 2.000, 1.970, 1.883,
1.750, 1.587, 1.413, 1.250, 1.117, 1.030, 1.000]

As discussed above, travel-product price-volatility in general may vary according to the travel day of the week and time of day. In some embodiments, such factors may be combined into a single “time of week” factor, as visualized in chart 704.

As discussed above, in various embodiments, the data from which chart 704 may be derived may be stored and/or represented in any suitable data structure. For example, in one embodiment, graph data corresponding to chart 704 (in which adjustment values vary according to a time/week of travel) may be represented and/or stored in a key:value data structure as follows:

| | |
|---|---|
| “0” | 0.75 |
| “1”: | 1 |
| “2”: | 1.25 |
| “3”: | 1.5 |
| “4”: | 1.25 |
| “5”: | 1 |
| “6”: | 0.75 |
| “7”: | 0.75 |
| “0.5”: | 0.75 |
| “1.5”: | 1 |
| “2.5”: | 1.25 |
| “3.5”: | 1.5 |
| “4.5”: | 1.25 |
| “5.5”: | 1 |
| “6.5”: | 0.75 |

In another embodiment, the same graph data may be stored and/or represented in an array or list indexed according to a value corresponding to the time/week of travel (e.g., 0-6, corresponding to “Sun”-“Sat”):

[0.750, 1.000, 1.250, 1.500, 1.250, 1.000, 0.750]

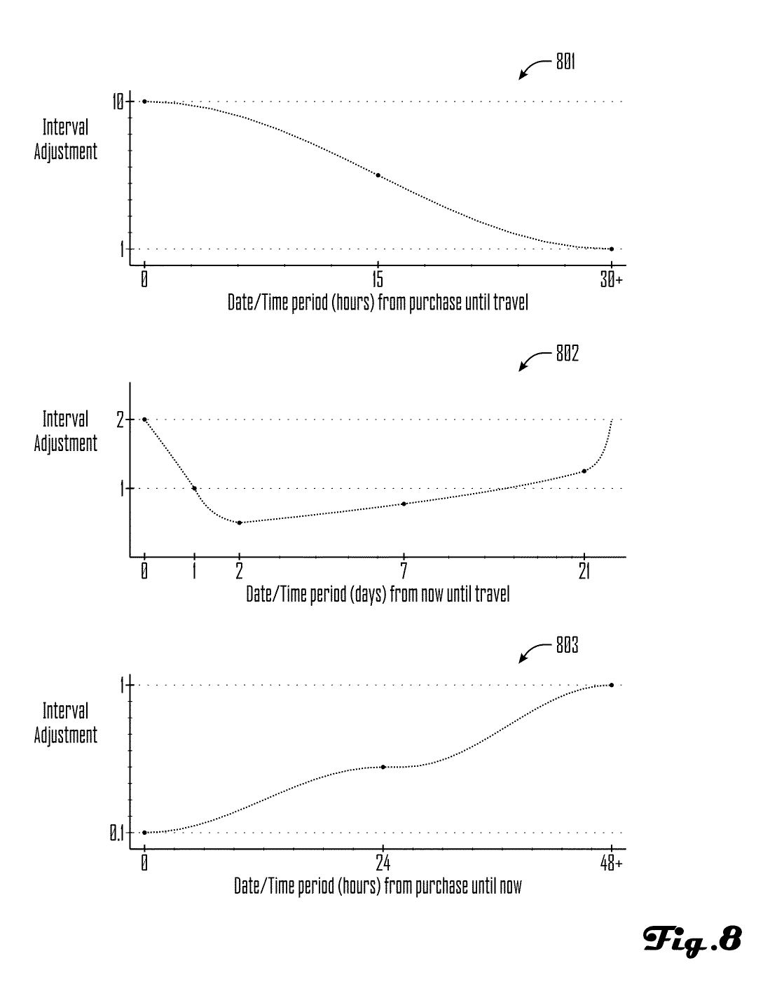

FIG. 8 illustrates several charts visualizing several exemplary price-volatility factors. More specifically, FIG. 8 illustrates exemplary price-volatility factors based on relative date/time. The price-volatility factor visualizations shown in FIG. 8 are intended to be merely illustrative of the concepts described herein, and not necessarily indicative of actual price-volatility-factor data that may be used in commercial embodiments.

In charts 801-803, the y-axis (Interval Adjustment) varies inversely according to the expected favorability for identifying a potentially improved travel product and/or travel-product price, according to the x-axis scale. As illustrated in charts 801-803, the y-axis represents a multiplier for increasing the interval (less frequent price-checks) or decreasing the interval (more frequent price-checks) according to price-volatility factors based on relative date/time.

For example, chart 801 illustrates that travel-product price-volatility in general decreases significantly when the travel-product is purchased less than 24 hours before the travel commences.

As discussed above, in various embodiments, the data from which chart 801 may be derived may be stored and/or represented in any suitable data structure. For example, in one embodiment, graph data corresponding to chart 801 (in which adjustment values vary according to a date/time period (hours) from purchase until travel) may be represented and/or stored in a key:value data structure as follows:

| | |
|---|---|
| “0”: | 10 |
| “30”: | 1 |

In another embodiment, the same graph data may be stored and/or represented in an array or list indexed according to a value corresponding to the date/time period (hours) from purchase until travel (e.g., 0-30):

[10.000, 9.975, 9.902, 9.780, 9.611, 9.397, 9.141, 8.844, 8.511,
8.145, 7.750, 7.330, 6.891, 6.436, 5.970, 5.500, 5.030, 4.564,
4.109, 3.670, 3.250, 2.855, 2.489, 2.156, 1.859, 1.603, 1.389,
1.220, 1.098, 1.025, 1.000]

Chart 802 illustrates that travel-product price-volatility in general varies according to the amount of time remaining before travel commences, with moderate volatility several weeks before travel, increasing to highest expected volatility a few days before travel, then decreasing as the travel date approaches.

As discussed above, in various embodiments, the data from which chart 802 may be derived may be stored and/or represented in any suitable data structure. For example, in one embodiment, graph data corresponding to chart 802 (in which adjustment values vary according to a date/time period (days) from now until travel) may be represented and/or stored in a key:value data structure as follows:

| | |
|---|---|
| “0”: | 2 |
| “1”: | 1 |
| “2”: | 0.5 |
| “21”: | 1.25 |
| “28”: | 2 |

In another embodiment, the same graph data may be stored and/or represented in an array or list indexed according to a value corresponding to the date/time period (days) from now until travel (e.g., 0-21):

[2.000, 1.000, 0.500, 0.561, 0.619, 0.673, 0.725, 0.775, 0.821,
0.866, 0.908, 0.948, 0.986, 1.021, 1.056, 1.088, 1.119, 1.148,
1.175, 1.202, 1.226, 1.250]

Chart 803 illustrates that in some cases (e.g., airline flight tickets), there may be a period of time (e.g., 24 hours) following the purchase during which the travel product may be voided or exchanged with no penalty. In such cases, price-checks may be scheduled with significantly increased frequency during such “void windows”. In various embodiments, chart 803 illustrates data that may be characterized as being associated with a booking-recency factor.

As discussed above, in various embodiments, the data from which chart 803 may be derived may be stored and/or represented in any suitable data structure. For example, in one embodiment, graph data corresponding to chart 803 (in which adjustment values vary according to a date/time period (hours) from purchase until now) may be represented and/or stored in a key:value data structure as follows:

| | |
|---|---|
| “0”: | 0.1 |
| “24”: | 0.5 |
| “26”: | 0.5 |
| “47”: | 1 |

In another embodiment, the same graph data may be stored and/or represented in an array or list indexed according to a value corresponding to the date/time period (hours) from purchase until now (e.g., 0-48):

[0.100, 0.102, 0.107, 0.115, 0.127, 0.141, 0.159, 0.178, 0.200,
0.223, 0.248, 0.274, 0.300, 0.326, 0.352, 0.377, 0.400, 0.422,
0.441, 0.459, 0.473, 0.485, 0.493, 0.498, 0.500, 0.500, 0.500,
0.503, 0.511, 0.525, 0.543, 0.567, 0.594, 0.625, 0.659, 0.694,
0.731, 0.769, 0.806, 0.841, 0.875, 0.906, 0.933, 0.957, 0.975,
0.989, 0.997, 1.000, 1.000]

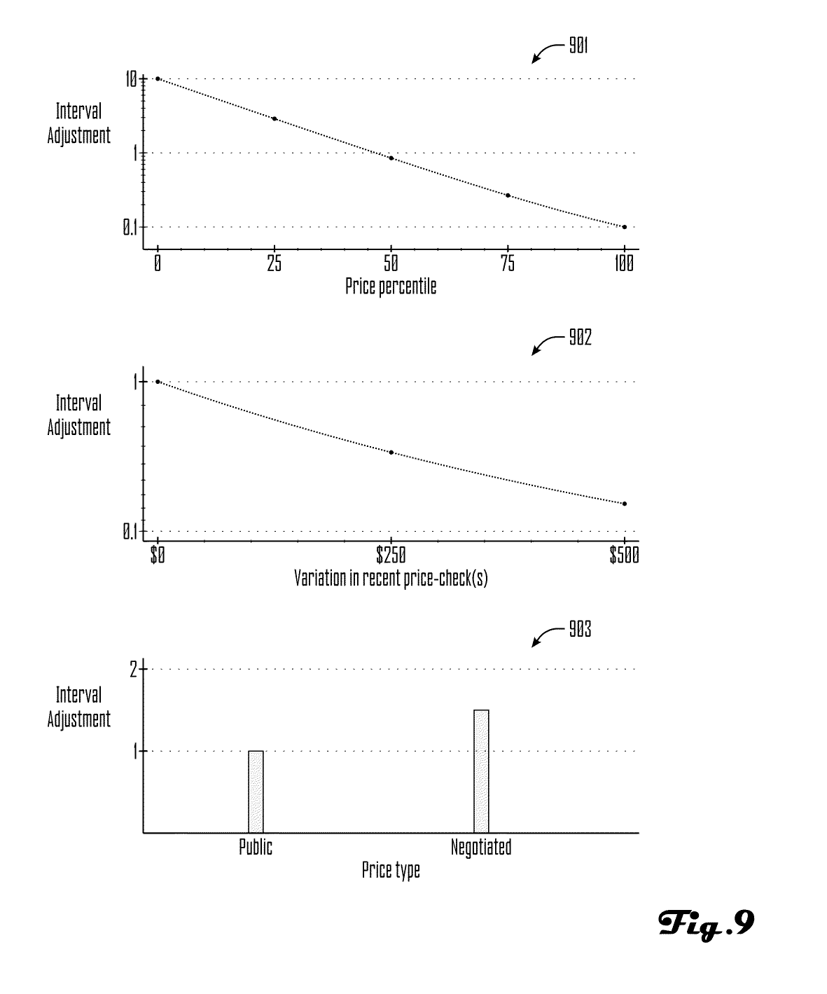

FIG. 9 illustrates several charts visualizing several exemplary price-volatility factors. More specifically, FIG. 9 illustrates exemplary price-volatility factors based on ticket price. The price-volatility factor visualizations shown in FIG. 9 are intended to be merely illustrative of the concepts described herein, and not necessarily indicative of actual price-volatility-factor data that may be used in commercial embodiments.

In charts 901-903, the y-axis (Interval Adjustment) varies inversely according to the expected favorability for identifying a potentially improved travel product and/or travel-product price, according to the x-axis scale. As illustrated in charts 901-903, the y-axis represents a multiplier for increasing the interval (less frequent price-checks) or decreasing the interval (more frequent price-checks) according to price-volatility factors based on ticket price.

For example, chart 901 illustrates that travel-products purchased at a relatively high price (i.e., those whose purchase price is in a high percentile of previously observed prices for similar travel products) are more likely to be improved upon than travel products that were purchased at a relatively low price (i.e., those whose purchase price is in a low percentile of previously observed prices for similar travel products). In various embodiments, chart 901 illustrates data that may be characterized as being associated with a comparative-price factor.

As discussed above, in various embodiments, the data from which chart 901 may be derived may be stored and/or represented in any suitable data structure. For example, in one embodiment, graph data corresponding to chart 901 (in which adjustment values vary according to a price percentile) may be represented and/or stored in a key:value data structure as follows:

| | |
|---|---|
| “0”: | 10 |
| “100”: | 0.1 |

In another embodiment, the same graph data may be stored and/or represented in an array or list indexed according to a value corresponding to the price percentile (e.g., 0-100):

[10.000, 9.514, 9.051, 8.612, 8.193, 7.795, 7.417, 7.057, 6.714,
6.388, 6.078, 5.783, 5.503, 5.236, 4.982, 4.741, 4.511, 4.293,
4.085, 3.888, 3.700, 3.521, 3.351, 3.189, 3.035, 2.888, 2.749,
2.617, 2.491, 2.371, 2.257, 2.148, 2.045, 1.947, 1.854, 1.765,
1.680, 1.600, 1.524, 1.451, 1.382, 1.316, 1.253, 1.194, 1.137,
1.083, 1.032, 0.983, 0.937, 0.893, 0.851, 0.811, 0.773, 0.737,
0.703, 0.670, 0.639, 0.609, 0.581, 0.555, 0.529, 0.505, 0.482,
0.460, 0.439, 0.419, 0.400, 0.383, 0.365, 0.349, 0.334, 0.319,
0.305, 0.292, 0.279, 0.267, 0.256, 0.245, 0.235, 0.225, 0.215,
0.206, 0.198, 0.190, 0.182, 0.175, 0.168, 0.161, 0.155, 0.149,
0.144, 0.138, 0.133, 0.128, 0.123, 0.119, 0.115, 0.111, 0.107,
0.103, 0.100]

Chart 902 illustrates that in some cases, a travel-product whose price has varied by several hundred dollars on one or more recent price checks may continue to show increased volatility in the near future. In such cases, price-checks may be scheduled with increased frequency following episodes of high observed variation. In various embodiments, chart 902 illustrates data that may be characterized as being associated with a recent-price-volatility factor.

As discussed above, in various embodiments, the data from which chart 902 may be derived may be stored and/or represented in any suitable data structure. For example, in one embodiment, graph data corresponding to chart 902 (in which adjustment values vary according to a variation in one or more recent price-checks) may be represented and/or stored in a key:value data structure as follows:

| | |
|---|---|
| “0”: | 1 |
| “500”: | 0.333 |

In another embodiment, the same graph data may be stored and/or represented in an array or list indexed according to a value corresponding to the variation in recent price-check(s) (e.g., 0-500 by 10, corresponding to “$0”-“$500”):

[1.000, 0.987, 0.973, 0.960, 0.947, 0.933, 0.920, 0.907, 0.893,
0.880, 0.867, 0.853, 0.840, 0.827, 0.813, 0.800, 0.787, 0.773,
0.760, 0.747, 0.733, 0.720, 0.707, 0.693, 0.680, 0.667, 0.653,
0.640, 0.627, 0.613, 0.600, 0.587, 0.573, 0.560, 0.547, 0.533,
0.520, 0.507, 0.493, 0.480, 0.467, 0.453, 0.440, 0.427, 0.413,
0.400, 0.387, 0.373, 0.360, 0.347, 0.333]

Chart 903 illustrates that travel-product price-volatility in general may decrease when the travel product was purchased at a negotiated rate that is not available to the general public.

As discussed above, in various embodiments, the data from which chart 903 may be derived may be stored and/or represented in any suitable data structure. For example, in one embodiment, graph data corresponding to chart 903 (in which adjustment values vary according to a price type) may be represented and/or stored in a key:value data structure as follows:

| | |
|---|---|
| Public: | 1 |
| Negotiated: | 1.5 |

In another embodiment, the same graph data may be stored and/or represented in an array or list indexed according to a value corresponding to the price type (e.g., 0-1, corresponding to “Public”-“Negotiated”):

[1, 1.5]

FIG. 10 illustrates several charts visualizing several exemplary price-volatility factors. More specifically, FIG. 10 illustrates exemplary price-volatility factors based on product provider. The price-volatility factor visualizations shown in FIG. 10 are intended to be merely illustrative of the concepts described herein, and not necessarily indicative of actual price-volatility-factor data that may be used in commercial embodiments.

In charts 1001-1002, the y-axis (Interval Adjustment) varies inversely according to the expected favorability for identifying a potentially improved travel product and/or travel-product price, according to the x-axis scale. As illustrated in charts 1001-1002, the y-axis represents a multiplier for increasing the interval (less frequent price-checks) or decreasing the interval (more frequent price-checks) according to price-volatility factors based on product provider.

For example, chart 1001 illustrates that travel-product price-volatility in general varies by airline (or other product provider).

As discussed above, in various embodiments, the data from which chart 1001 may be derived may be stored and/or represented in any suitable data structure. For example, in one embodiment, graph data corresponding to chart 1001 (in which adjustment values vary according to a airline) may be represented and/or stored in a key:value data structure as follows:

| | |
|---|---|
| AK: | 1.5 |
| US: | 1 |
| UA: | 1.4 |
| BA: | 0.7 |

In another embodiment, the same graph data may be stored and/or represented in an array or list indexed according to a value corresponding to the airline (e.g., 0-3, corresponding to “AK”-“BA”):

[1.5, 1, 1.4, 0.7]

Chart 1002 illustrates that travel-product price-volatility in general varies according to the competitiveness of the product. For example, in the case of airline flights, competitiveness (and thus price-volatility) may vary according to travel route or origin/destination pair.

As discussed above, in various embodiments, the data from which chart 1002 may be derived may be stored and/or represented in any suitable data structure. For example, in one embodiment, graph data corresponding to chart 1002 (in which adjustment values vary according to a route competitiveness) may be represented and/or stored in a key:value data structure as follows:

| | |
|---|---|
| “0”: | 1 |
| “1”: | 2 |

In another embodiment, the same graph data may be stored and/or represented in an array or list indexed according to a value corresponding to the route competitiveness (e.g., 0-1, corresponding to “Competitive”-“Non-competitive”):

[1.000, 2.000]

FIG. 11 illustrates several charts visualizing several exemplary price-volatility factors. More specifically, FIG. 11 illustrates exemplary price-volatility factors based on ticket/product. The price-volatility factor visualizations shown in FIG. 11 are intended to be merely illustrative of the concepts described herein, and not necessarily indicative of actual price-volatility-factor data that may be used in commercial embodiments.

In charts 1101-1104, the y-axis (Interval Adjustment) varies inversely according to the expected favorability for identifying a potentially improved travel product and/or travel-product price, according to the x-axis scale. As illustrated in charts 1101-1104, the y-axis represents a multiplier for increasing the interval (less frequent price-checks) or decreasing the interval (more frequent price-checks) according to price-volatility factors based on ticket/product.

For example, chart 1101 illustrates that tickets for first-class and business-class seats may be price-checked at more frequent intervals than those for economy seats at least in part because larger value opportunities may exist for first-class and business class tickets than for economy class tickets. In various embodiments, chart 1101 illustrates data that may be characterized as being associated with a class-of-service factor.

As discussed above, in various embodiments, the data from which chart 1101 may be derived may be stored and/or represented in any suitable data structure. For example, in one embodiment, graph data corresponding to chart 1101 (in which adjustment values vary according to a cabin class) may be represented and/or stored in a key:value data structure as follows:

| | |
|---|---|
| First: | 0.75 |
| Business: | 0.5 |
| Economy: | 1 |

In another embodiment, the same graph data may be stored and/or represented in an array or list indexed according to a value corresponding to the cabin class (e.g., 0-2, corresponding to “First”-“Economy”):

[0.75, 0.5, 1]

Chart 1102 illustrates that flight ticket price-volatility in general varies by service class, with highly discounted fares (e.g., “V” class) exhibiting less volatility than more expensive classes of service (e.g., “J” or “F” class). In various embodiments, chart 1102 illustrates data that may be characterized as being associated with a class-of-service factor.

As discussed above, in various embodiments, the data from which chart 1102 may be derived may be stored and/or represented in any suitable data structure. For example, in one embodiment, graph data corresponding to chart 1102 (in which adjustment values vary according to a service class) may be represented and/or stored in a key:value data structure as follows:

| | |
|---|---|
| Y: | 0.75 |
| K: | 1.1 |
| L: | 1 |
| M: | 1 |
| J: | 0.5 |
| F: | 0.5 |
| C: | 1 |
| Q: | 1.5 |
| V: | 2 |

In another embodiment, the same graph data may be stored and/or represented in an array or list indexed according to a value corresponding to the service class (e.g., 0-8, corresponding to “Y”-“V”):

[0.75, 1.1, 1, 1, 0.5, 0.5, 1, 1.5, 2]

Chart 1103 illustrates that one-way flight tickets may exhibit less price volatility than round-trip flight tickets.

As discussed above, in various embodiments, the data from which chart 1103 may be derived may be stored and/or represented in any suitable data structure. For example, in one embodiment, graph data corresponding to chart 1103 (in which adjustment values vary according to a ticket type) may be represented and/or stored in a key:value data structure as follows:

| | |
|---|---|
| One way: | 1.5 |
| Round trip: | 1 |

In another embodiment, the same graph data may be stored and/or represented in an array or list indexed according to a value corresponding to the ticket type (e.g., 0-1, corresponding to “One way”-“Round trip”):

[1.5, 1]

Chart 1104 illustrates that “no-penalty” flight tickets may be price-checked at more frequent intervals than “penalty” flight tickets at least in part because the lack of a change fee means that more potential saving can be captured for a given price drop.

As discussed above, in various embodiments, the data from which chart 1104 may be derived may be stored and/or represented in any suitable data structure. For example, in one embodiment, graph data corresponding to chart 1104 (in which adjustment values vary according to a penalty ticket status) may be represented and/or stored in a key:value data structure as follows:

| | |
|---|---|
| Penalty: | 1 |
| No Penalty: | 0.75 |

In another embodiment, the same graph data may be stored and/or represented in an array or list indexed according to a value corresponding to the penalty ticket status (e.g., 0-1, corresponding to “Penalty”-“No Penalty”):

[1, 0.75]

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1. A price-monitoring-server-implemented method for dynamically scheduling travel-product price checks, the method comprising:
obtaining, by the price-monitoring server, a request to monitor future prices associated with a travel ticket that was purchased at a purchase price at a previous date and/or time, said previously-purchased travel ticket entitling a purchaser to obtain a travel product at a future date and/or time;
determining, by the price-monitoring server, an original plurality of price-volatility factors associated with said previously-purchased travel ticket;
modifying, by the price-monitoring server, a base price-check interval according to each of said original plurality of price-volatility factors to determine a travel-ticket-specific price-check interval;
performing, by the price-monitoring server, at least one price check to determine a current price associated with said previously-purchased travel ticket after said travel-ticket-specific price-check interval has passed;
periodically re-evaluating, by the price-monitoring server, at least some of said original plurality of price-volatility factors to obtain a plurality of updated price-volatility factors;
periodically determining, by the price-monitoring server, an updated price-check interval based at least in part on said plurality of updated price-volatility factors and an un-updated subset of said original plurality of price-volatility factors; and
periodically scheduling, by the price-monitoring server, a subsequent price check to occur after said updated price-check interval has passed.

2. The method of claim 1, wherein periodically re-evaluating at least some of said original plurality of price-volatility factors comprises:
periodically determining a price difference between at least one recently obtained price associated with said previously-purchased travel ticket and said purchase price and/or at least one previously obtained price associated with said previously-purchased travel ticket; and
evaluating said price difference to determine a recent-price-volatility factor.

3. The method of claim 2, wherein periodically determining said updated price-check interval comprises, during at least one update period:
shortening said updated price-check interval according to said recent-price-volatility factor when recent price-volatility is determined to be high.

4. The method of claim 1, wherein determining said original plurality of price-volatility factors comprises:
determining a historical price range associated with travel tickets that are identical or comparable to said previously-purchased travel ticket; and
ranking said purchase price according to said historical price range to determine a comparative-price factor.

5. The method of claim 4, wherein modifying said base price-check interval according to said comparative-price factor comprises:
lengthening said base price-check interval when said purchase price is low compared to said historical price range; and
shortening said base price-check interval when said purchase price is high compared to said historical price range.

6. The method of claim 1, wherein determining said original plurality of price-volatility factors comprises:
determining a class of service associated with said previously-purchased travel ticket; and
evaluating said class of service to determine a class-of-service factor corresponding to an interval modifier for modifying said base price-check interval.

7. The method of claim 1, wherein determining said original plurality of price-volatility factors comprises:
determining a date and/or time period between a current date and/or time and said previous-purchase date and/or time; and
evaluating said date and/or time period to determine a booking-recency factor.

8. The method of claim 7, wherein modifying said base price-check interval according to said booking-recency factor comprises:
shortening said base price-check interval when said previously-purchased travel ticket was recently booked.

9. The method of claim 1, wherein determining said original plurality of price-volatility factors comprises:
determining a date and/or time period between a current date and/or time and said future-travel date and/or time; and
evaluating said date and/or time period to determine a travel-imminence factor corresponding to an interval modifier for modifying said base price-check interval.

10. The method of claim 1, wherein determining said original plurality of price-volatility factors comprises evaluating said future-travel date and/or time to determine a travel-date-and/or-time factor corresponding to an interval modifier for modifying said base price-check interval.

11. The method of claim 1, wherein said previously-purchased travel ticket comprises:
a flight ticket; and
wherein said travel product comprises an airline flight.

12. A computing apparatus for dynamically scheduling travel-product price checks, the apparatus comprising a processor and a memory storing instructions that, when executed by the processor, configure the apparatus to:
obtain a request to monitor future prices associated with a travel ticket that was purchased at a purchase price at a previous date and/or time, said previously-purchased travel ticket entitling a purchaser to obtain a travel product at a future date and/or time;
determine an original plurality of price-volatility factors associated with said previously-purchased travel ticket;
modify a base price-check interval according to each of said original plurality of price-volatility factors to determine a travel-ticket-specific price-check interval;
perform at least one price check to determine a current price associated with said previously-purchased travel ticket after said travel-ticket-specific price-check interval has passed;
periodically re-evaluate at least some of said original plurality of price-volatility factors to obtain a plurality of updated price-volatility factors;
periodically determine an updated price-check interval based at least in part on said plurality of updated price-volatility factors and an un-updated subset of said original plurality of price-volatility factors; and
periodically schedule a subsequent price check to occur after said updated price-check interval has passed.

13. The apparatus of claim 12, wherein the instructions that configure the apparatus to periodically re-evaluate at least some of said original plurality of price-volatility factors further comprise instructions configuring the apparatus to:
periodically determine a price difference between at least one recently obtained price associated with said previously-purchased travel ticket and said purchase price and/or at least one previously obtained price associated with said previously-purchased travel ticket; and
evaluate said price difference to determine a recent-price-volatility factor.

14. The apparatus of claim 13, wherein periodically determining said updated price-check interval comprises, during at least one update period:
shorten said updated price-check interval according to said recent-price-volatility factor when recent price-volatility is determined to be high.

15. The apparatus of claim 12, wherein the instructions that configure the apparatus to determine said original plurality of price-volatility factors further comprise instructions configuring the apparatus to:
determine a historical price range associated with travel tickets that are identical or comparable to said previously-purchased travel ticket; and
rank said purchase price according to said historical price range to determine a comparative-price factor.

16. The apparatus of claim 15, wherein modifying said base price-check interval according to said comparative-price factor comprises:
lengthen said base price-check interval when said purchase price is low compared to said historical price range; and
shorten said base price-check interval when said purchase price is high compared to said historical price range.

17. A non-transient computer-readable storage medium having stored thereon instructions that, when executed by a processor, configure the processor to:
obtain a request to monitor future prices associated with a travel ticket that was purchased at a purchase price at a previous date and/or time, said previously-purchased travel ticket entitling a purchaser to obtain a travel product at a future date and/or time;
determine an original plurality of price-volatility factors associated with said previously-purchased travel ticket;
modify a base price-check interval according to each of said original plurality of price-volatility factors to determine a travel-ticket-specific price-check interval;
perform at least one price check to determine a current price associated with said previously-purchased travel ticket after said travel-ticket-specific price-check interval has passed;
periodically re-evaluate at least some of said original plurality of price-volatility factors to obtain a plurality of updated price-volatility factors;
periodically determine an updated price-check interval based at least in part on said plurality of updated price-volatility factors and an un-updated subset of said original plurality of price-volatility factors; and
periodically schedule a subsequent price check to occur after said updated price-check interval has passed.

18. The storage medium of claim 17, wherein the instructions that configure the processor to periodically re-evaluate at least some of said original plurality of price-volatility factors further comprise instructions configuring the processor to:
periodically determine a price difference between at least one recently obtained price associated with said previously-purchased travel ticket and said purchase price and/or at least one previously obtained price associated with said previously-purchased travel ticket; and
evaluate said price difference to determine a recent-price-volatility factor.

19. The storage medium of claim 18, wherein periodically determining said updated price-check interval comprises, during at least one update period:
shorten said updated price-check interval according to said recent-price-volatility factor when recent price-volatility is determined to be high.

20. The storage medium of claim 17, wherein the instructions that configure the processor to determine said original plurality of price-volatility factors further comprise instructions configuring the processor to:
determine a historical price range associated with travel tickets that are identical or comparable to said previously-purchased travel ticket; and
rank said purchase price according to said historical price range to determine a comparative-price factor.

21. The storage medium of claim 20, wherein modifying said base price-check interval according to said comparative-price factor comprises:
lengthen said base price-check interval when said purchase price is low compared to said historical price range; and
shorten said base price-check interval when said purchase price is high compared to said historical price range.
